(19) United States
(12) Patent Application Publication
(10) Pub. No.: US 2015/0106530 A1
(43) Pub. Date: Apr. 16, 2015

(54) Communication Efficiency

(71) Applicant: Nokia Corporation, Espoo (FI)

(72) Inventors: Olli Petteri Alanen, Vantaa (FI); Jarkko Lauri Sakari Kneckt, Espoo (FI); Janne Marin, Espoo (FI)

(73) Assignee: Nokia Corporation, Espoo (FI)

(21) Appl. No.: 14/054,201

(22) Filed: Oct. 15, 2013

(51) Int. Cl. H04W 80/04

(52) U.S. Cl. CPC H04W 80/04
USPC 709/231

(57) ABSTRACT

There is provided a solution in which a wireless node is caused to configure a plurality of transport layer protocol streams for a communication with another node via at least one communication path, wherein each transport layer protocol stream has a different maximum segment size; monitor at least one performance parameter of each communication path between the wireless node and the other node; and select at least one transport layer protocol stream for the communication on the basis of the monitoring.

### FIELD

The invention relates generally to improving communication efficiency of a wireless communication system.

### BACKGROUND

Transmission control protocol (TCP) is one of the protocols in the internet protocol (IP) suite. The TCP, and other transport layer protocols, may be used to deliver data streams between programs running on computers connected to internet, for example. The TCP may control the transmission by dividing the data to be transmitted into segments and by forwarding the segments to an IP layer, which encapsulates each data segment into an IP packet. Thereafter, the IP packet may be transmitted to the receiver. However, the current manner of generating the data segments may not provide an efficient communication between the transmitter and the receiver.

### BRIEF DESCRIPTION OF THE INVENTION

According to an aspect of the invention, there is provided a method as specified in claim 1.

According to an aspect of the invention, there are provided apparatuses as specified in claims 10 and 21.

According to an aspect of the invention, there is provided a computer program product as specified in claim 20.

According to an aspect of the invention, there is provided a computer-readable distribution medium carrying the above-mentioned computer program product.

According to an aspect of the invention, there is provided an apparatus comprising means for performing any of the embodiments as described in the appended claims.

Embodiments of the invention are defined in the dependent claims

### LIST OF THE DRAWINGS

In the following, the invention will be described in greater detail with reference to the embodiments and the accompanying drawings, in which

FIG. 1 presents a network, according to an embodiment;

FIGS. 2 and 10 show methods, according to some embodiments;

FIG. 3 shows example TCP streams, according to an embodiment;

FIG. 4 illustrates how there may be limitations for selecting the maximum segment size (MSS) for a given communication path, according to an embodiment;

FIGS. 5A and 5B illustrates some examples on how some performance parameters may affect the selection of the MSS, according to some embodiments

FIG. 6 depicts how thresholds may be used in selection of a TCP stream, according to an embodiment;

FIGS. 7 and 8 illustrates how a terminal may control the use of the TCP streams, according to some embodiments; and

FIG. 9 illustrates an apparatus, according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

The number of IEEE 802.11-enabled mobile devices is increasing. The IEEE 802.11 is a set of standards for implementing wireless local area network (WLAN), also known as the Wi-Fi. Such an IEEE 802.11-enabled station (STA), such as user terminal/equipment 100 in FIG. 1, may associate and communicate with an access node/point (AP) 102, 104. The STA 100 may comprise a mobile phone, a palm computer, a wrist computer, a laptop, a personal computer, or any device capable to access the wireless radio access network, such as the WLAN. The access node 102, 104 may be a WLAN (IEEE 802.11) access point (e.g. Wi-Fi base stations), for example. Each station 100 and the AP 102, 104 may apply a transport layer protocol, such as a transmission control protocol (TCP), for transmitting data over the network. The TCP may reside on a transport layer in an internet protocol (IP) suite. As said, the TCP may be responsible of generating data segments for transmission as IP packets, for example.

Another radio communication network, such as the Long Term Evolution (LTE) or the LTE-Advanced (LTE-A) of the 3rd Generation Partnership Project (3GPP), may also be present in the area. Such cellular communication network is typically composed of at least one base station 106 providing coverage to a cell covering a geographical area. The base station 106 may be, e.g., a node B (NB) as in the LTE or an evolved node B (eNB) as in the LTE-A.

In presence of several access nodes 102-106 (i.e. the APs 102, 104 and the eNB 106), the STA 100 may have an option of a communicating with another node 108 in the network through a multipath TCP (MP-TCP). One of the aims of the MP-TCP may be to allow a TCP connection to use one or many communication paths 112-116 to maximize resource usage and increase communication efficiency. However, different communication paths 112-116 may have different communication performances, such as physical layer (PHY) transmission rates and transmission errors. Similarly, the situation in a single communication path may vary in time.

The difference of the minimum and maximum (PHY transmission rate of, e.g., wireless radio access network (WLAN) radio is becoming very large. The lowest transmission rate may be 1 Mbit/s in the legacy 802.11b. In an orthogonal frequency division multiplexing (OFDM) based 802.11a, the lowest transmission rate may be 6 Mbit/s while the highest transmission rate of the 802.11ac may be 5 Gbit/s. Therefore, it may be beneficial to have multiple TCP connections available for a single communication path.

Similarly, the size of the transmitted packets, such as a Physical Layer Convergence Protocol (PLCP) Protocol Data Unit (PPDU), may vary. E.g. it may be possible to aggregate multiple medium access service (MAC) Service Data Units (MSDUs) to a single transmitted PPDU. Such frame aggregation mechanisms may create larger transmitted PPDUs. The PPDUs with large payload may require longer transmission periods than shorter PPDUs. However, owing to such aggregation, the overheads due to data preamble and acknowledgements transmissions may be reduced.

One alternative to transmit these large packets may be to fragment the packet to smaller transmitted pieces. Each piece may be transmitted and acknowledged separately. All the transmissions of the fragmented frame may be done within the same transmission opportunity (TXOP). However, this may result to a long TXOP and violate the TXOPLimit procedure.

The source of the TCP stream may generate packets, wherein the size of the packet is constrained by the maximum segment size (MSS). Typically the TCP segment size is set to 1500 octets to enable a single packet delivery in the network. However, the use of a single static value of the MSS is not optimal in terms of the communication efficiency.

For example, when a low PHY transmission rate is present, the transmission of the 1500 octet frame may take a long time with the low transmission rate. Further, such long duration may increase the likelihood of transmission errors due to interference or hidden terminal problem during the transmission. Also the retransmissions of the frames may become complicated. Therefore, it may be advantageous, in some cases, to decrease the MSS.

On the other hand, when a high PHY transmission rate is used, the 1500 octet frame size may increase overheads due to IP headers, for example. Further, the handling of larger number of packets to be transmitted consumes transmission resources. As such, increasing the MSS may be appropriate for some cases as large delivery rates may be more optimally utilized with large frame sizes. The large frame sizes may increase efficiency because larger packets may require less packet forwarding decisions, which may increase the operation efficiency of the router and because larger data packets may reduce the amount of header overheads. As such, one static MSS for any/all communication paths 112-116 may not be optimal.

In order to mitigate at least the above mentioned problems, there is provided a solution for selecting the MSS dynamically in order to optimize the communication efficiency, e.g. by maximizing the air interface performance in a MP-TCP configuration. Such packet size optimization may increase link efficiency and reduce overheads on each communication path 112-116. Further, the proposal may enable efficient retransmission mechanism on each communication path 112-116 in case of a low PHY rate transmission rate and efficient frame delivery in case of a high PHY transmission rate. Yet, the proposal may help in avoiding the complicated data fragmentation.

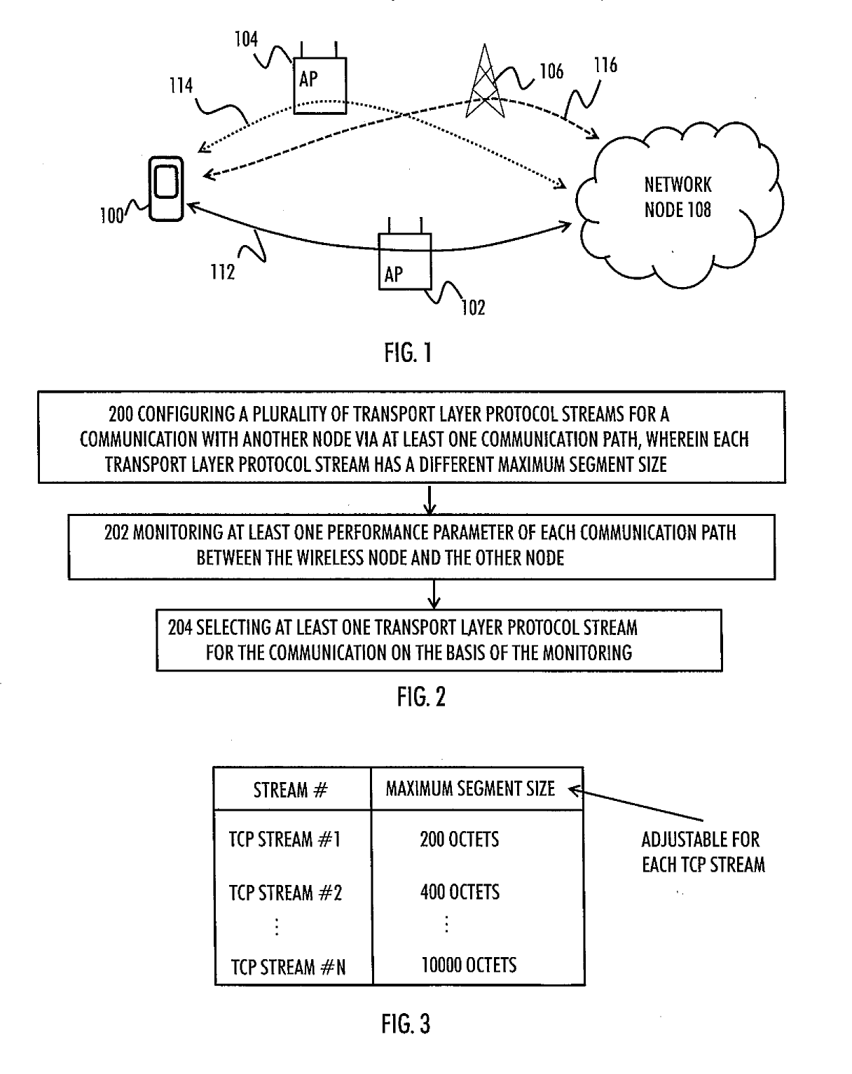

Accordingly, it is proposed, as shown in FIG. 2, that the STA 100 configures, in step 200, a plurality of TCP streams for a communication with another node (such as with the network node 108) via at least one communication path 112-116. Further, as shown in FIG. 3, a different maximum segment size (MSS) is set for each TCP stream. The values given for the MSS in FIG. 3 are merely for illustrative purposes and may vary from those shown. However, in an embodiment, different TCP streams comprise MSS values below and above 1500 octets. One TCP stream may also comprise an MSS value of 1500 octets, although not shown in FIG. 3. A skilled person may understand that the configuration of the TCP streams may also comprise setting other parameters to each TCP stream than only the MSS value. As a result, there may be several TCP streams which are ready to be applied for communication.

In an embodiment, the STA 100 may have only a single path (e.g. the path 112) available for the communication. This may be the case when the STA 100 knows only the IP addresses of the source (i.e. the STA 100) and destination (i.e. the node 108) devices. In an embodiment, during the MP-TCP setup, the STA 100 may automatically setup multiple TCP connections for the same single path, e.g. to the path 112, and thus enable fast adjustment of the TCP stream parameters in varying link conditions for that path 112. In an embodiment, the STA 100 may set different port numbers for the communication in order to enable two TCP streams to exist simultaneously.

In an embodiment, the STA 100 initially applies a default TCP stream for the communication on the at least one path 112-116. This default TCP stream may be pre-coded to the STA 100, or it may be signalled to the STA 100 at some point of network access. In an embodiment, the default TCP stream applies 1500 octets as the MSS. In an embodiment, the default MSS is selected based on history information of the corresponding communication path/link. For example, if it is seen that some value for the MSS provides good communication performance (such as good data rate or low error rate), then this MSS may be selected as the default MSS to start with, at least for the corresponding communication link.

As said, in an embodiment, in the beginning, the STA 100 may communicate with the node 108 via at least one of the paths 112-116 by applying one of the plurality of configured MP-TCP streams, wherein the TCP streams may have an individually set MSS. However, as indicated earlier, using a static MSS value in a path may not be the most optimal from the communication performance point of view.

Accordingly, in step 202, the STA may monitor at least one performance parameter of each on-going communication path 112-116 between the STA 100 and the other node 108. In step 204, the STA 100 may then select at least one TCP stream for the communication on the basis of the monitoring. Selecting a TCP stream for a communication path simultaneously means selecting a desired MSS for the corresponding communication path 112-116.

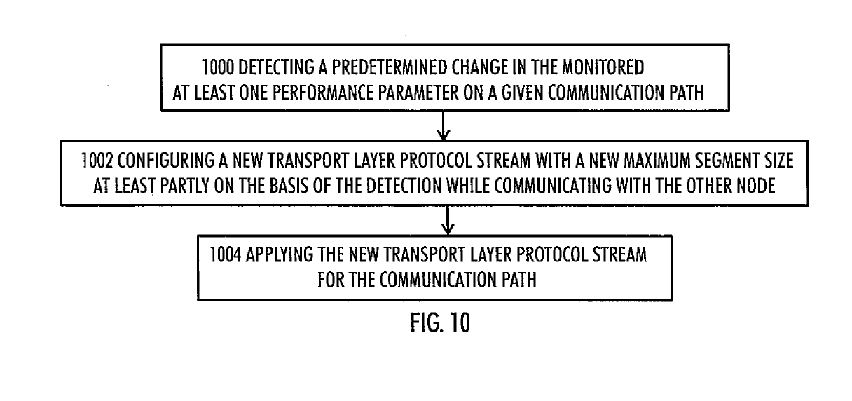

In an embodiment, as shown in FIG. 10, the STA 100 may detect in step 1000 a predetermined change in the monitored at least one performance parameter on a given communication path, e.g. the path 112. Such predetermined change may comprise detecting that the monitored performance parameter exceeds a certain transmission rate threshold, for example. The predetermined change to be monitored may be set previously based on empirical derivation or mathematical modelling. The predetermined change may be set to such a value which is not currently supported by any of the already configured TCP streams. For example, if a transmission rate of the communication changes to a value which is not optimally supported by any of the already configured TCP streams, then the predetermined change may be detected to have taken place.

Thereafter, the STA 100 may in step 1002, while communicating with the node 108 on the currently applied TCP stream, configure a new TCP stream with a new MSS at least partly on the basis of the detection. This new MSS value may be selected such that it is enough for optimally supporting the current link conditions represented by the at least one monitored parameter. Accordingly, the STA 100 may then in step 1004 select the new transmission protocol stream for that communication path 112. In other words, the STA 100 may replace the currently used TCP stream with the new TCP stream having more suitable MSS value and apply that new TCP stream for the communication on that path 112.

In an embodiment, the STA 100 may like to change the parameters of the TCP stream softly and dynamically. Therefore, during the STA 100 configures (opens) the at least one new TCP stream e.g. for the communication path 112, the STA 100 may continue operating with the old TCP stream on that path 112. Thus, the MP-TCP may enable taking the new TCP stream softly into use without erasing the old TCP connection, if seen appropriate. On the other hand, if the situation changes, the old TCP connection may be taken into use again.

In an embodiment, in a case there are multiple (at least two) communication paths applied, the STA 100 communicates via multiple paths 112 and 114 using different WLAN connections. Therefore, the at least two communication paths 112-116 may comprise a first association between the STA 100 and a first access node (e.g. the AP 102) and a second association between the STA 100 and a second access node (e.g. the AP 104). In an embodiment, the STA 100 communicates via multiple paths using multiple other radio access connections (e.g. multiple LTE connections, e.g. the link 114). In yet one embodiment, the STA 100 may communicate via multiple paths 112/114 and 116 using both of a first radio system (e.g. WLAN, connections 112 or 114) and a second radio system (e.g. the LTE).

In an embodiment, the STA 100 selects in step 204 at least two TCP streams for the communication. This may comprise selecting only a first TCP stream for transmitting a first packet and selecting only a second TCP stream for transmitting a second packet. Thus, in this case two TCP streams may be selected and each selected TCP stream carries one packet to the target. In this embodiment, a single TCP stream is used for data transmission at a time. The used TCP stream may be selected to optimize the transmission of the packet at hand.

In an embodiment, the maximum TCP segment size and, consequently, the TCP stream, for a communication path 112-116 is selected to favour a predetermined communication performance parameter of the corresponding path 112-116. In an embodiment, different TCP streams may be tested to detect how different MSSs of the different TCP streams affect the performance parameter on a given communication path. Such testing may be constantly on-going. For example, the STA 100 may, in an embodiment, start with a default TCP stream having a default MSS value, e.g. 1500 octets. Thereafter, the STA 100 may estimate e.g. uplink (UL) and/or downlink (DL) performance (e.g. throughput) with that MSS value. The STA 100 may then select a new TCP stream with a different MSS. Then the STA 100 may monitor the communication performance parameter with this new MSS value. In case the new TCP stream with the new MSS performs better, then that TCP stream may be selected for the corresponding communication path. Moreover, in an embodiment, that TCP stream may be thereafter used as the default TCP stream and that MSS may be thereafter used as the default MSS value.

In an embodiment, the STA 100 may detect the size of data unit generated by an aggregation (e.g. aggregate MAC protocol data unit (MPDU) and an aggregate MAC service data unit (MSDU) which may be used before the transmission. In an embodiment, the MSS is set to be the size of the A-MSDU. This may correspond to the size of one acknowledged data unit in the radio interface.

In an embodiment, as illustrated in FIG. 3, the STA 100 may adjust the MSS of at least one TCP stream based at least partly on the monitoring of the performance parameter. E.g. if it is noted that certain TCP stream does not provide good enough (e.g. above a certain threshold) performance in, at least most of the situations, then the STA 100 may decide to adjust the MSS of that TCP stream to another value which may perform better.

In an embodiment, the STA 100 may select the TCP stream and, consequently, the MSS for the at least one communication path 112, 114, 116 according to a radio link performance and limitations in the used transmission path 112, 114, 116. In an embodiment, the MSS is set to the maximum TCP packet size which still avoids the packet fragmentation to smaller packets. The MSS may be configured in the TCP stream setup. Further, any router in the used TCP path may limit the MSS value, as will be explained.

In an embodiment, a negotiation between the TCP path endpoints may be used to negotiate the MSS to be applied. In an embodiment, the MSS is direction dependent. E.g. each communication party may define the MSS that a peer device is required to use towards it.

Let us now look at closer how different performance parameters may be used in selecting a different TCP stream or in adjusting the MSS value of a TCP stream. The used performance parameter may represent data throughput of the communication path and, hence, the communication performance of that communication path.

In an embodiment, the selection of the TCP stream for the at least one communication path 112-116 and thus the maximum segment size, is based on the transmission error rate at the air interface. E.g. the transmission error rate of the air interface may be coordinated by a link adaptation protocol. The link adaptation may target to maintain a specific transmission error rate or to minimize the error rate. In such cases, the maximum TCP MSS may be, e.g. empirically or mathematically selected to either keep the error rate according to the target error rate or to minimize the error rate and, thus, to maximize link throughput. It may be noted that in case of a low transmission rate, in presence of hidden terminals, or in presence of other power emitters in the same band, the link adaptation may not be able to ensure the transmission error rate to the desired level. Each retransmission may cause inefficiency of the communication, also partly due to the headers of the retransmission frames. In such cases, the MSS may be selected as a compromise of the TCP protocol, air interface and retransmission overhead. For example, if the obtained transmission rate varies at the air interface, the terminal 100 may balance the MSS to use lower values in order to enable smaller duration to the retransmitted packets in low rates. On the other hand, if the link performance is not varying, the device 100 may apply an MSS size that is optimized to minimize the overheads of the current transmission rate.

In an embodiment, the selection of the TCP stream, and thus the maximum segment size, is based on the transmission error rate on the TCP path. E.g. the TCP path may drop TCP packets due to transmission errors of the source, poor performing routers on the delivery path, or high congestion of the networks. In an embodiment, in case the STA 100 detects that many transmitted TCP packets are missing based on the TCP sequence numbers, the STA 100 may start detecting (e.g. empirically testing) does the MSS affect to the error rate. Upon detecting that another MSS provides less errors, the STA 100 may tune the maximum segment size accordingly or select another TCP stream having the more suitable MSS value.

In an embodiment, the selection of the TCP stream, and thus the maximum segment size, is based on PHY transmission rate at the air interface. E.g. the PHY transmission rate may vary which may result in retransmissions to take place. In these scenarios, the STA 100 may desire to use a lower MSS to enable greater flexibility for retransmissions. In an embodiment, the PHY transmission rate may consider frame sizes which use MPDU durations of 0.5 ms or 0.7 ms, for example. Such frame sizes may enable efficient use of frame aggregation. Further, such duration may have room to tolerate degradation of the transmission rate. E.g. even if the PHY rate is halved, the aggregations have flexibility to utilize the most of the duration allowed by the TXOPLimit—parameter.

In an embodiment, the selection of the TCP stream, and thus the maximum segment size, is based on limitations of the TCP path. In such case, the STA 100 may detect any limitations with respect to the transmitted packet sizes over a given communication path 112, 114, 116. Thereafter, the STA 100 may select, for the corresponding communication path, a transmission control protocol stream having a maximum segment size which is within the detected limits.

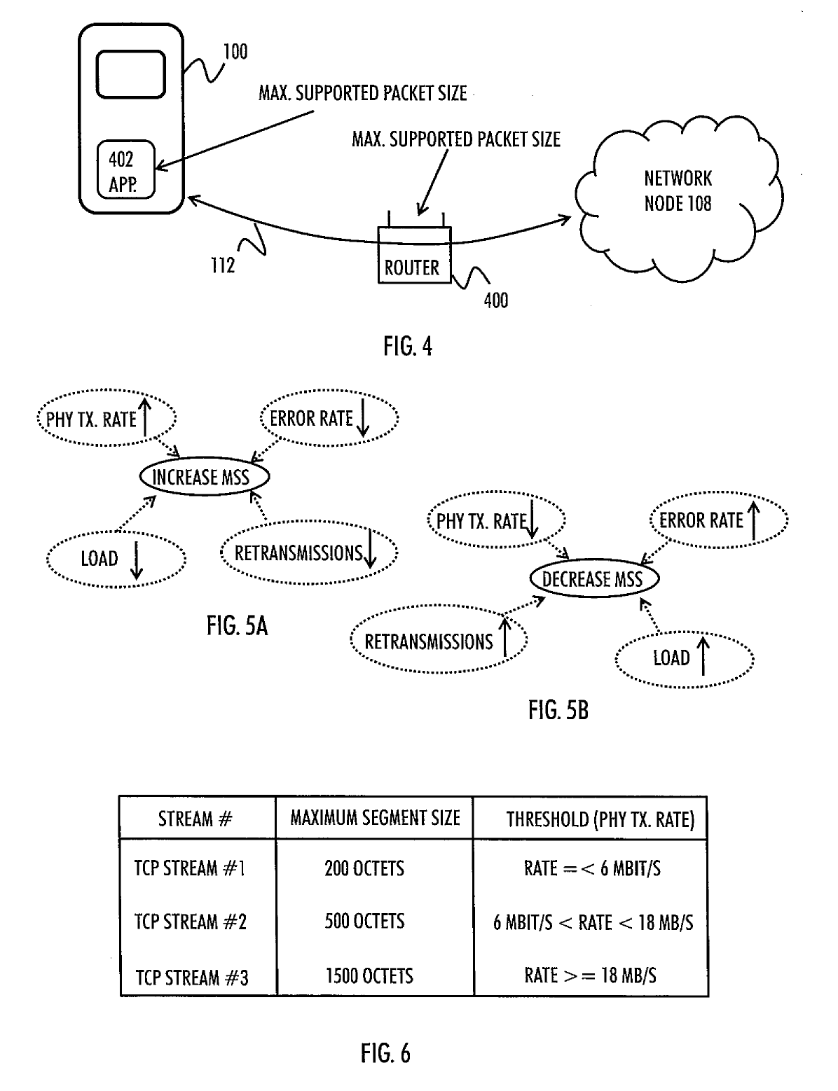

E.g. in an embodiment, as shown in FIG. 4, the STA 100 may determine the maximum packet size which is supported by any router 400 on the communication path, e.g. the path 112. This upper limit may be detected based on testing. Such testing of the TCP path may be performed while having an operational TCP stream on-going between the STA 100 and the node 108, for example. Consequently, the STA 100 may select, for this communication path 112, a TCP stream having a MSS which is, at maximum, equal to the supported maximum packet size in order to avoid data fragmentation. In this way the MSS may be limited so that it does not exceed the maximum segment size supported by any of the routers 400 on the delivery path 112. If the STA 100 selected a TCP stream with a larger MSS, the IP packets might be fragmented to multiple segments and one IP packet would be received only when all segments are delivered correctly. This may results in an increased packet dropping (error) rate.

As another example for obeying the detected limitations, in an embodiment, also shown in FIG. 4, the selection of the TCP stream, and thus the maximum segment size, is based on applications 402 running in the STA 100. The STA 100 may determine the maximum packet size which is supported an application 402 responsible of data transmission in the STA 100. For example, the application 402 may not generate data segments corresponding to the currently used MSS. This upper limit set by the application may be detected based on the identifier of the application 402 or by analysing the application behaviour. Consequently, the STA 100 may select a TCP stream having a MSS which is, at maximum, equal to the supported maximum packet size in order to avoid data fragmentation. E.g. the STA 100 may select a TCP stream so that the application 402 need not split the IP packet to multiple segments and is capable to transmit one packet per segment. For instance, some VoIP applications may generate fixed length packets, or they may generate a packet having a length selected from a set of lengths. Also in such cases, the STA 100 may select such an MSS value which enables the VoIP applications to transmit one packet in a one TCP segment.

In an embodiment, the selection of the TCP stream, and thus the maximum segment size, is based on overheads of the traffic. E.g. the STA 100 may reduce the IP, TCP and MAC headers of the traffic and try to maximize the data throughput. For instance, each transmitted TCP segment has IP, TCP, and MAC headers. These headers may increase the overhead of the transmission. As a consequence, the STA 100 may decide to select a TCP stream having a larger MSS so that the same payload data is more efficiently transmitted with fewer headers. Similarly acknowledgment (ACK) headers may need to be considered when selecting the segment size. In other words, small packets may increase the amount of ACK headers which may indicate towards using larger MSS.

However, the STA 100 may also need to consider the headers in the retransmitted packets. In case too large MSS size is selected, the amount of retransmission may increase. Therefore, the selection of the correct MSS to be used for a given communication path 112-116 may require testing and/or mathematical modelling in order to determine which MSS provides the best comprise between the retransmission and the overhead of headers, for example. It should be noted that the properties of the communication path 112, 114, 116 (air interface, network load, hardware (e.g. routers) on that path) may affect the TCP stream selection for that specific path 112, 114, 116.

In one example, in case the AP 102 is not an 802.11n high throughput (HT) AP, 802.11ac, very high throughput (VHT) or other aggregation capable AP, the STA 100 may decide to use a large TCP segment size. This is because in these situations, the lack of aggregation capability of the AP may result to a very poor performance with small MSS values.

In an embodiment, the selection of the TCP stream, and thus the maximum segment size, is based on monitoring the performance parameter of the on-going communication.

However, in an embodiment, the selection of the TCP stream, and thus the maximum segment size, is based on future performance. In this embodiment, the STA 100 may estimate the future performance of each communication path at least partly on the basis of motion information of the STA 100. Then the monitored performance parameter comprises at least one estimated future performance parameter. E.g. the STA 100 may estimate the future of the transmission rate as one performance parameter. For instance, if the STA 100 has moved away from the AP 102, the STA 100 may estimate that the coming transmission rate is lower than if the STA 100 were closer to the AP 102. The STA 100 may then use this estimated performance parameter value in the selection of the TCP stream for the at least one path 112-116. In an embodiment, the STA 100 intentionally underestimates the future performance, e.g. the STA 100 may intentionally estimate a lower transmission rate than the STA 100 actually expects. This may be helpful because the performance loss due to retransmissions is typically larger than the efficiency gain of the correct estimation of the future performance parameter.

In an embodiment, the STA 100 may estimate the frequency of how often a setup of the TCP streams is needed and how long time a TCP stream setup takes. In an embodiment, it may be advantageous that the STA 100 may configure at least one new TCP stream during communication with the other node 108 is on-going on another TCP stream. However, in some cases such parallel configuration of new TCP streams is not possible. This may be due to limitations of the STA 100 and/or the node 108, or due to the fact that simultaneous TCP stream setup may require such a long time that delays complicate the communication. In such cases where the STA 100 is not able to make the parallel TCP stream setup, the STA 100 may decide to select such TCP stream parameters that reduce the number and frequency of TCP stream setups needed. E.g. three TCP streams may have MSSs values of 500 octets (for low data rate cases), 1500 octets, and 10000 octets (for high data rate cases or if high communication performance is expected).

FIGS. 5A and 5B show some examples for selecting another TCP stream having a higher (FIG. 5A) or a lower (FIG. 5B) MSS. As shown in FIG. 5A, upon detecting or estimating at least one of the following with respect to a communication path 112, 114, 116: increase in the PHY transmission rate, decrease in the traffic load, decrease in the transmission error rate, decrease in the number of retransmissions, the STA 100 may select for the corresponding communication path 112, 114, or 116 a TCP stream having a larger MSS. This may enhance the communication efficiency as the path 112, 114, or 116 is good enough for transmitting data packets in larger sizes.

On the other hand, as shown in FIG. 5B, upon detecting or estimating at least one of the following with respect to a communication path 112, 115, 116: decrease in the PHY transmission rate, increase in the load, increase in the transmission error rate, and increase in the number of retransmissions, the STA 100 may select for the corresponding communication path 112, 114, or 116 a TCP stream having a lower MSS. This may be beneficial as the corresponding communication path 112, 114, 116 may provide such a poor performance that transmitting large packets would increase the need of retransmissions. Therefore, decreasing the MSS for that communication path 112, 114, 116 may increase the communication efficiency in this case.

As said, the performance parameter may represent the current performance or the estimated future performance. For example, if the terminal considers that traffic load will increase, the STA 100 may select a more conservative (smaller) segment sizes. This is because the traffic load may increase the transmission error rate in which case applying a TCP stream with an MSS value which is more tolerable to transmission errors may be advantageous.

The parameters of e.g. FIG. 5A may be interrelated in the sense that when the load increases, the error rate may increase as well. However, in some situations it may be quicker to detect the increase in the traffic load first so that the TCP stream may be changed already before the error rate starts increasing.

In an embodiment, as shown in FIG. 6, the STA 100 may set at least one threshold for the monitored performance parameter on a given communication path 112, 114, 116. The STA 100 may itself determine the thresholds, e.g. on the basis of history knowledge on that path 112, 114, 116, the thresholds may be indicated to the STA 100, or the STA 100 may be pre-coded with the threshold values. The threshold values given in FIG. 6 are merely for illustrative purposes and actual thresholds may or may not vary from the ones shown in FIG. 6.

Let us assume that the STA 100 has created three TCP streams with MSS values of 200 octets, 500 octets and 1500 octets. The STA 100 may then determine performance parameter thresholds that may be used to control which of the three TCP streams is to be used for the data frame transmission on that communication path 112, 114, 116 for which the thresholds are set. E.g. upon detecting that any of the set at least one threshold is met, the STA 100 may select, for that communication path, another TCP stream having a different MSS. It may be so that each communication path 112, 114, 116 has individual thresholds, which may be based on the properties of the corresponding path or of the radio access network providing the corresponding path.

As an example, let us assume that the monitored performance parameter is the PHY transmission rate. If the transmission rate is less than 6 Mbit/s, the STA 100 may decide to use the TCP stream having a MSS of 200 octets. If the transmission rate is between 6 Mbit/s and 18 Mbit/s, the STA 100 may decide to use the TCP stream having a MSS of 500 octets. Finally, if the transmission rate is above than 18 Mbit/s, the STA 100 may decide to use the TCP stream having a MSS of 1500 octets.

In an embodiment, the maximum TCP segment size for a given communication path 112, 114, 116 may be determined as

MSS=Tx_{dur}_{_{—}}_{of}_{_{—}}_{ACK}*TX_{Rate},

wherein the Tx_{dur}_{_{—}}_{of}_{_{—}}_{ACK} corresponds to the transmission duration of an acknowledged unit. In an embodiment, a size of the acknowledged unit may be 1000 microseconds. Parameter TX_{Rate} is the assumed PHY transmission rate. The MSS may be set at the TCP stream setup process.

In an embodiment, the STA 100 may create new TCP streams according to the link requirements. E.g. if none of the currently configured TCP streams comprise a desired MSS value, the STA 100 may create a new TCP stream. Similarly, unused, old TCP stream(s) may be deleted, possibly on the basis of the current and/or estimated link conditions. For instance, if the PHY transmission rate decreases in a given link, the STA 100 may create a new TCP stream with a smaller maximum segment size, or select one of the already available TCP streams having a lower MSS value. On the other hand, if the PHY transmission rate increases in a given link, the STA 100 may generate a TCP stream with larger segment size, or select one of the already available TCP streams having a higher MSS value.

In an embodiment, a TCP flow management function of the STA 100 controls the TCP stream/flow selection. If the transmissions run smoothly in a high transmission rate case, the TCP stream with largest MSS may be used on that communication path. If the transmission of the packets causes problems (e.g. increase in the error rate) with the high MSS, a TCP stream/flow with a smaller MSS may be selected for that communication path.

In an embodiment, in case the STA 100 considers that too many TCP streams are already operating in the MP-TCP (which may increase complexity of the, especially if the STA 100 communicates with multiple servers), the STA 100 may delete some streams which are least used or which provide lowest communication performance. Moreover, deleting some stream(s) may serve as a way for forcing the future traffic to use other TCP streams.

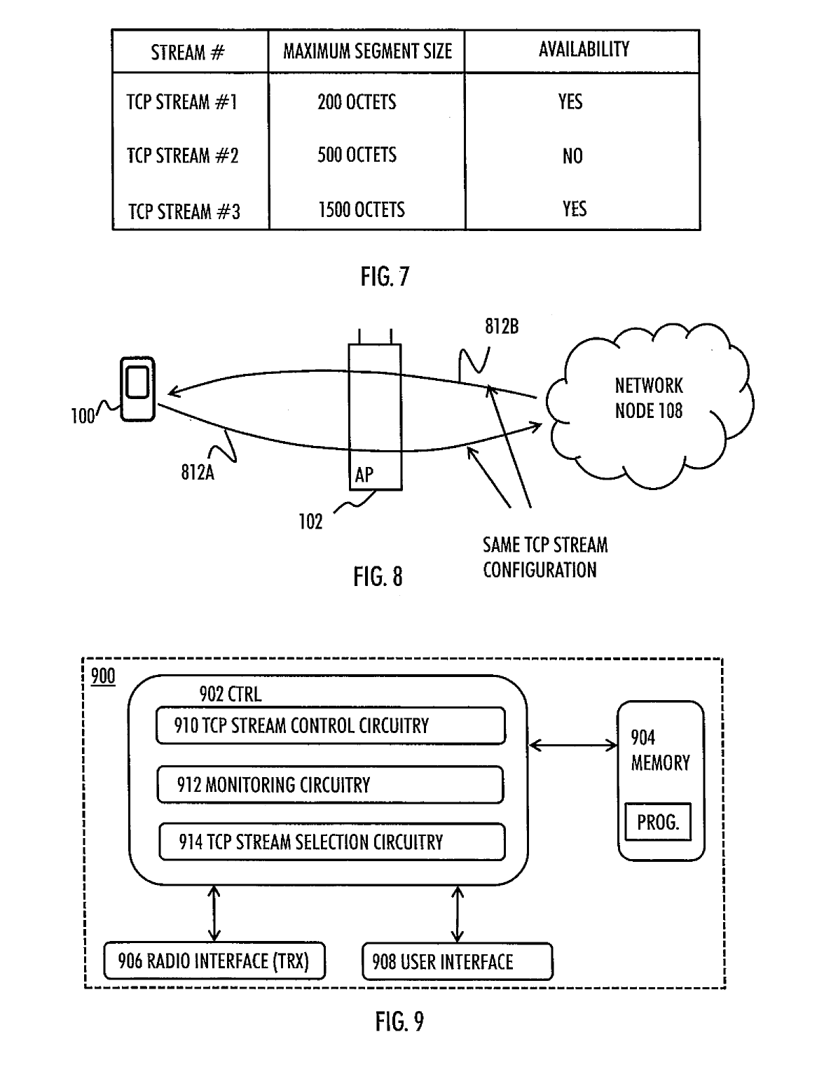

In an embodiment, as shown in FIG. 7, the STA 100 may set at least one of the plurality of TCP streams into a non-available (back-up) mode. For example, in FIG. 7, the TCP streams #1 and #3 are available but the TCP stream #2 is set in the back-up mode. The STA 100 may indicate, to the node 108, the at least one TCP stream (e.g. the TCP stream #2) in the non-available mode, thereby controlling the availability of the TCP streams for the node 108. In this way, the STA 100 may control which TCP stream the other communication party 108 uses because the indicated TCP sub-flows are not available for use by the communication party 108. Such signalling may also help in cases where both communication parties 100, 108 are experiencing changes in the PHY transmission rates.

The use of the non-available mode may enable soft transition between the TCP streams within a single path 112. It is to be noted that the source and the destination IP addresses may have multiple TCP connections, and the back-up mode may indicate which one(s) is/are in use. In an embodiment, when multiple TCP connections are in use within the same link 112, the MP-TCP mechanism may balance the traffic load between the TCP streams.

In an embodiment, the STA 100 may then detect a predetermined change in the at least one performance parameter. Such predetermined change may comprise detecting that the monitored performance parameter exceeds a certain transmission rate threshold, for example. The predetermined change to be monitored may be set previously based on empirical derivation or mathematical modelling. Further, it may be that the TCP stream most appropriate for the changed conditions may be currently in the non-available mode. Accordingly, the STA 100 may set at least one of the transmission control protocol streams in the non-available mode into an available mode. This may be done in order to enable the use of the availed at least one transmission control protocol stream in the communication under the changed conditions. In this way, the TCP connection content is maintained and the adjustment and adaptation to the new link conditions may be fast.

In an embodiment, as shown in FIG. 8, the STA 100 may indicate, to the communication party 108, that the communication party 108 is to apply the same TCP stream configuration in a communication 812B towards the STA 108 as the STA 100 applies in a communication 812A towards the communication party 108. That is, the TCP stream that is used for transmission by the STA 100 (e.g. in the UL) defines also the TCP stream used for transmission by the node 108 (e.g. in the DL). This embodiment may serve in situations where traffic is transmitted in both directions.

In an embodiment, an access point or a peer-to-peer communication server may establish at least one TCP stream to the STA 100. The STA 100 may then have at least one TCP stream to the AP or to the peer-to-peer server and at least another stream to the node 108. The AP or the peer-to-peer communication server may control the used packet sizes towards the STA 100 based on the data delivery rate to the STA 100. E.g. in case the data delivery rate is slower than a predetermined threshold, the server may adjust and use smaller packet size toward the terminal 100. This operation may allow the terminal 100 and the server (source of the DL traffic) to use a legacy TCP.

When an access point, such as the AP 102, is terminating the TCP stream, the AP may know the radio link performance to the STA 100. Then the AP 102 may select the used DL packet size to avoid complicate retransmissions and inefficiencies in data transmission.

Although, the specification uses WLAN network as an example network, the proposed TCP segment size is not specific to any network type or topology, but the embodiments may be used in multiple different radio access network types and in different topologies such as Wi-Fi direct, mesh, and ad hoc topologies. Example radio access technologies (RATs) in which the embodiments may be applicable to may include: WLAN (Wi-Fi, IEEE 802.11), 60 GHz networks, Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), and/or LTE-Advanced. The present embodiments are not, however, limited to these protocols.

Although explained so that the STA 100 is the communicating party performing the embodiments, in another embodiment, the communicating party performing at least some of the described embodiments is an access point or a STA serving as an access point. Accordingly, the access point may communicate by applying the MP-TCP and by selecting at least one TCP stream for the communication on the basis of the communication performance monitored by the access point.

Although explained so that the TCP is the transport layer protocol, there may be other transport layer protocols which may apply at least some of the proposed embodiments. Alternatives for the TCP may comprise Datagram Congestion Control Protocol (DCCP), for example.

An embodiment, as shown in FIG. 9, provides an apparatus 900 comprising a control circuitry (CTRL) 902, such as at least one processor, and at least one memory 904 including a computer program code (PROG), wherein the at least one memory 904 and the computer program code (PROG), are configured, with the at least one processor 902, to cause the apparatus 900 to carry out any one of the embodiments. The memory 904 may be implemented using any suitable data storage technology, such as semiconductor based memory devices, flash memory, magnetic memory devices and systems, optical memory devices and systems, fixed memory and removable memory.

In an embodiment, the apparatus 900 may comprise the terminal device of a wireless network system, e.g. a user equipment (STA), a user terminal (UT), a computer (PC), a laptop, a tabloid computer, a cellular phone, a mobile phone, a communicator, a smart phone, a palm computer, or any other communication apparatus. Alternatively, the apparatus 900 is comprised in such a terminal device. Further, the apparatus 900 may be or comprise a module (to be attached to the apparatus) providing connectivity, such as a plug-in unit, an “USB dongle”, or any other kind of unit. The unit may be installed either inside the apparatus or attached to the apparatus with a connector or even wirelessly. In an embodiment, the apparatus 900 may be, comprise or be comprised in a wireless device, such as the STA 100. In an embodiment, the apparatus 900 may be comprised in an access point or STA operating under the IEEE 802.11, for example. In yet one embodiment, the STA or AP may operate according to some other radio access network.

The apparatus may further comprise communication interface (TRX) 906 comprising hardware and/or software for realizing communication connectivity according to one or more communication protocols. The TRX 906 may provide the apparatus 900 with communication capabilities to access the radio access network, for example.

The apparatus 900 may also comprise a user interface 908 comprising, for example, at least one keypad, a microphone, a touch display, a display, a speaker, etc. The user interface 908 may be used to control the apparatus 900 by the user.

The control circuitry 902 may comprise a TCP stream control circuitry 910 for creating, deleting, re-configuring the TCP streams according to any of the embodiments. A monitoring circuitry 912 may be for monitoring at least one predetermined parameter representing communication performance on a given path or paths 112-116. The monitoring circuitry 912 may also be responsible of estimating the future performance of the communication and, thus, how the at least one performance parameter is expected to change. A TCP stream selection circuitry 914 may be for selecting the at least one TCP stream for the communication.

As used in this application, the term ‘circuitry’ refers to all of the following: (a) hardware-only circuit implementations, such as implementations in only analog and/or digital circuitry, and (b) combinations of circuits and soft-ware (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. Coding of software for carrying out the embodiments as shown and described is well within the scope of a person of ordinary skill in the art.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
configuring, by a wireless node, a plurality of transport layer protocol streams for a communication with another node via at least one communication path, wherein each transport layer protocol stream has a different maximum segment size;
monitoring at least one performance parameter of each communication path between the wireless node and the other node; and
selecting at least one transport layer protocol stream for the communication on the basis of the monitoring.

2. The method of claim 1, further comprising:
detecting a predetermined change in the monitored at least one performance parameter on a given communication path;
configuring a new transport layer protocol stream with a new maximum segment size at least partly on the basis of the detection while communicating with the other node; and
selecting the new transport layer protocol stream for the communication path.

3. The method claim 1, wherein the monitored performance parameter comprises at least one of a transmission error rate, a physical layer transmission rate, traffic load.

4. The method of claim 1, further comprising:
upon detecting or estimating at least one of the following with respect to a given communication path: increase in the transmission rate, decrease in the traffic load, decrease in the transmission error rate, and decrease in the number of retransmissions, selecting a transport layer protocol stream having a larger maximum segment size for the communication path; and
upon detecting or estimating at least one of the following with respect to a given communication path: decrease in the transmission rate, increase in the traffic load, increase in the transmission error rate, and increase in the number of retransmissions, selecting a transport layer protocol stream having a lower maximum segment size for the communication path.

5. The method of claim 1, further comprising:
determining the maximum packet size which is supported by at least one of the following: a router on a given communication path and an application responsible of data transmission in the wireless node; and
selecting, for the communication path, a transport layer protocol stream having a maximum segment size which is, at maximum, equal to the supported maximum packet size in order to avoid data fragmentation.

6. The method of claim 1, further comprising:
setting at least one threshold for the monitored performance parameter on a given communication path; and
upon detecting that the at least one threshold is met, selecting, for the communication path, another transport layer protocol stream having a different maximum segment size.

7. The method of claim 1, further comprising:
setting at least one of the plurality of transport layer protocol streams into a non-available mode;
indicating, to the other node, the at least one transport layer protocol stream in the non-available mode, thereby controlling the availability of the transport layer protocol streams for the other node;
detecting a predetermined change in the at least one performance parameter; and
setting at least one of the non-available transport layer protocol streams into an available mode in order to use the availed at least one transport layer protocol stream in the communication.

8. The method of claim 1, further comprising:
selecting at least two transport layer protocol streams for communication on at least two communication paths on the basis of the monitoring, wherein the at least two communication paths comprise a first association between the wireless node and a first access node and a second association between the wireless node and a second access node.

9. The method of claim 1, wherein selecting the at least two transport layer protocol streams for the communication comprises selecting only a first transport layer protocol stream for transmitting a first packet and selecting only a second transport layer protocol stream for transmitting a second packet.

10. An apparatus, comprising:
at least one processor and at least one memory including a computer program code, wherein the at least one memory and the computer program code are configured, with the at least one processor, to cause the apparatus at least to:
configure a plurality of transport layer protocol streams for a communication with another node via at least one communication path, wherein each transport layer protocol stream has a different maximum segment size;
monitor at least one performance parameter of each communication path between the apparatus and the other node; and
select at least one transport layer protocol stream for the communication on the basis of the monitoring.

11. The apparatus of claim 10, wherein the at least one memory and the computer program code are configured, with the at least one processor, to cause the apparatus further to:
detect a predetermined change in the monitored at least one performance parameter on a given communication path;
configure a new transport layer protocol stream with a new maximum segment size at least partly on the basis of the detection while communicating with the other node; and
select the new transport layer protocol stream for the communication path.

12. The apparatus of claim 10, wherein the monitored performance parameter comprises at least one of a transmission error rate, a physical layer transmission rate, traffic load.

13. The apparatus of claim 10, wherein the at least one memory and the computer program code are configured, with the at least one processor, to cause the apparatus further to:
upon detecting or estimating at least one of the following with respect to a given communication path: increase in the transmission rate, decrease in the traffic load, decrease in the transmission error rate, and decrease in the number of retransmissions, select a transport layer protocol stream having a larger maximum segment size for the communication path; and
upon detecting or estimating at least one of the following with respect to a given communication path: decrease in the transmission rate, increase in the traffic load, increase in the transmission error rate, and increase in the number of retransmissions, select a transport layer protocol stream having a lower maximum segment size for the communication path.

14. The apparatus of claim 10, wherein the at least one memory and the computer program code are configured, with the at least one processor, to cause the apparatus further to:
determine the maximum packet size which is supported by at least one of the following: a router on a given communication path and an application responsible of data transmission in the apparatus; and
select, for the communication path, a transport layer protocol stream having a maximum segment size which is, at maximum, equal to the supported maximum packet size in order to avoid data fragmentation.

15. The apparatus of claim 10, wherein the at least one memory and the computer program code are configured, with the at least one processor, to cause the apparatus further to:
set at least one threshold for the monitored performance parameter on a given communication path; and
upon detecting that the at least one threshold is met, select, for the communication path, another transport layer protocol stream having a different maximum segment size.

16. The apparatus of any of claim 10, wherein the at least one memory and the computer program code are configured, with the at least one processor, to cause the apparatus further to:
set at least one of the plurality of transport layer protocol streams into a non-available mode;
indicate, to the other node, the at least one transport layer protocol stream in the non-available mode, thereby controlling the availability of the transport layer protocol streams for the other node;
detect a predetermined change in the at least one performance parameter; and
set at least one of the non-available transport layer protocol streams into an available mode in order to use the availed at least one transport layer protocol stream in the communication.

17. The apparatus of claim 10, wherein the at least one memory and the computer program code are configured, with the at least one processor, to cause the apparatus further to:
select at least two transport layer protocol streams for communication on at least two communication paths on the basis of the monitoring, wherein the at least two communication paths comprise a first association between the apparatus and a first access node and a second association between the apparatus and a second access node.

18. The apparatus of claim 10, wherein selecting the at least two transport layer protocol streams for the communication comprises selecting only a first transport layer protocol stream for transmitting a first packet and selecting only a second transport layer protocol stream for transmitting a second packet.

19. The apparatus of claim 10, wherein the apparatus is a user terminal operating at least under the wireless local area network of the IEEE 802.11.

20. A computer program product embodied on a distribution medium readable by a computer and comprising program instructions which, when loaded into an apparatus, cause the apparatus at least to:
configure a plurality of transport layer protocol streams for a communication with another node via at least one communication path, wherein each transport layer protocol stream has a different maximum segment size;
monitor at least one performance parameter of each communication path between the apparatus and the other node; and
select at least one transport layer protocol stream for the communication on the basis of the monitoring.

21-29. (canceled)
